(19) United States
(12) Patent Application Publication
(10) Pub. No.: US 2012/0151723 A1
(43) Pub. Date: Jun. 21, 2012

(54) DISPLAY LOCK DEVICE

(76) Inventor: Hideyuki Hirota, Tokyo (JP)

(21) Appl. No.: 13/391,753

(22) PCT Filed: Jan. 25, 2010
(86) PCT No.: PCT/JP2010/000392

§ 371 Date: Feb. 22, 2012

(51) Int. Cl. F16B 21/04

(52) U.S. Cl. 24/595.1

(57) ABSTRACT

When a display unit 3 is pressed, a clamper 12 is also pressed together, and a rotational drive unit inside a holder 17 converts a reciprocating motion of the clamper 12 into a rotational motion to rotate the clamper 12. An engaging protrusion 12a is engaged with and disengaged from an engaging recess 6a of the display unit 3 with the rotation of the clamper 12 to switch between a locked state and a lock-released state in the display unit 3.

### TECHNICAL FIELD

The present invention relates to a display lock device that locks the opening and closing of a display.

### BACKGROUND ART

In a conventional ceiling hanging display device, a display unit is openably and closably connected to a housing fixed to a ceiling surface: when the display device is not in use, a display unit is accommodated and locked in the housing, while when in use, the lock is released, and then the display unit is opened in a lower direction of the housing, so that a screen thereof is directed towards a viewer.

A lock release button is disposed on the lower face of the housing in order to lock the display unit in a state where the latter is contained in the housing, and a clamper interlocking with the lock release button is provided within the housing to thus engage the clamper with an engaging hole provided on the side of the display unit. When the viewer presses the lock release button, the clamper is interlocked with the lock release button to be disengaged from the engaging hole, which allows the display unit to be opened and closed.

A large number of display lock structures have been conventionally disclosed for operating a clamper by providing a lock release button, and include: for example, a structure such that a lock release button pushes up one end of a clamper, while the other end of the clamper is lowered correspondingly to be disengaged from an engaging hole; and a structure such that an action in a perpendicular direction of a lock release button is converted into an action in the horizontal direction of a clamper, whereby the clamper is pulled out from an engaging hole with sliding (for instance, Patent Document 1).

### PRIOR ART DOCUMENTS

### Patent Documents

Patent Document 1: JP-A-2002-240642

### SUMMARY OF THE INVENTION

Since the conventional display lock device is configured as described above, there is a problem such that the number of parts is increased because of the required lock release button. Also, it is necessary that a space for arranging the lock release button be provided within the housing.

The present invention is made to solve the above problems, and it is an object of the present invention to provide a display lock device configured to switch between a locked state and a lock-released state by direct pressing of the display unit to eliminate a lock release button and a housing space for arranging the button.

A display lock device of the invention includes: a clamper to be reciprocated due to the pressing of the display when the display is pressed; a rotational drive unit connected to one end of the clamper to convert a reciprocating motion of the clamper into a rotational motion to thus rotate the clamper; and an engaging protrusion protrusively provided on a side of the clamper to be engaged with or disengaged from an engaging recess formed in the display with the rotation of the clamper.

According to the invention, a reciprocating motion of the clamper to be reciprocated due to the pressing of the display is converted into a rotational motion to switch between a locked state and a lock-released state in the display unit by the clamper; thus, a lock release button and a housing space for arranging the button can be eliminated.

### BRIEF DESCRIPTION OF THE DRAWINGS

FIG. 1 is a partly cross-sectional view showing a configuration where a display lock device of Embodiment 1 in the present invention is applied to a ceiling hanging display device; FIG. 1(a) and FIG. 1(b) show a locked state and a lock-released state thereof, respectively.

FIG. 2 is an external perspective view showing the configuration of the display lock device of Embodiment 1; FIG. 2(a) and FIG. 2(b) show the locked state and the lock-released state thereof, respectively.

FIG. 3 is an exploded perspective view showing the configuration of the display lock device of Embodiment 1.

FIG. 4 is an external perspective view showing a clamper and a shaft integrated with each other.

FIG. 5 shows the locked state in FIG. 5(a), a forward motion state of the clamper in FIG. 5(b), and the lock-released state in FIG. 5(c) with respect to the display lock device of Embodiment 1.

FIG. 6 shows a forward motion state of the clamper in FIG. 6(a) and a backward motion state in the display lock device of Embodiment 1.

FIG. 7 shows an external perspective view of the integrated structure of the clamper and shaft in FIG. 7(a), and a cross-sectional view taken along line AA in FIG. 7(b).

FIG. 8 is a plan view of the integrated structure shown in FIG. 7(b); FIG. 8(a) shows an integrating procedure thereof, and FIG. 8(b) shows a disassembling procedure thereof.

FIG. 9 is an external perspective view showing a modification of the clamper and shaft shown in Embodiment 1.

### BEST MODE FOR CARRYING OUT THE INVENTION

In the following, to explain the present invention in more detail, embodiments for carrying out the invention will be described with reference to the accompanying drawings. Embodiment 1.

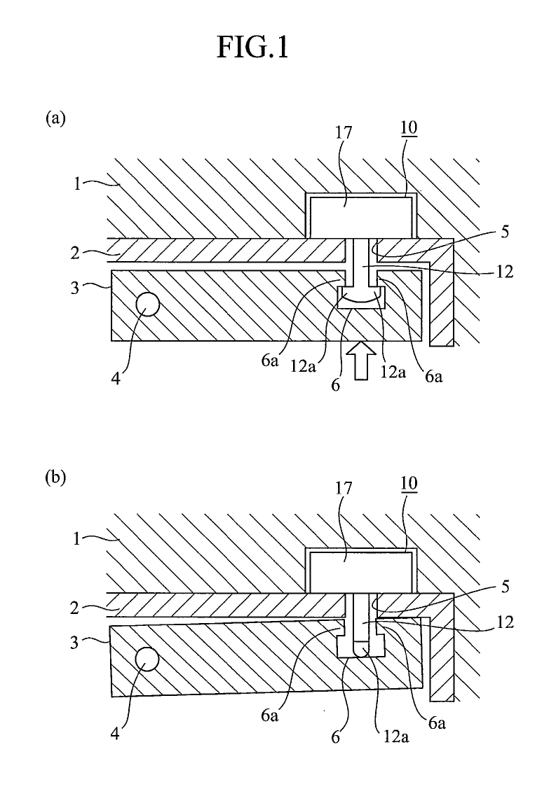

As shown in FIG. 1(a), in a ceiling hanging display device, a housing 2 fixed to a ceiling surface 1 and a display unit 3 is openably and closably connected to each other by way of a connecting unit 4; when a clamper 12 of the display lock device 10 of the invention and a clamper engaging hole 6 of the display unit 3 are engaged with each other, the display unit 3 is locked with held inside the housing 2.

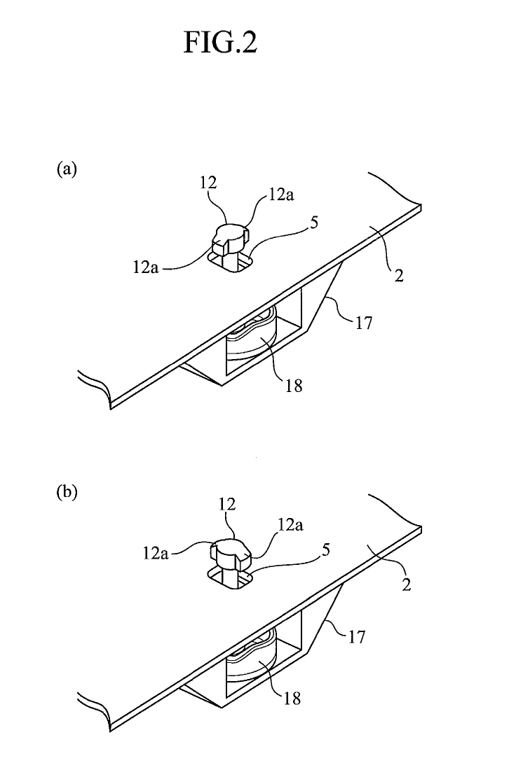

As shown in FIG. 1 and FIG. 2, a rotational drive unit that is caused to rotate through conversion of a reciprocating motion by the clamper 12 to a rotational motion is disposed at the base end side of the clamper 12. A holder 17 that covers a rotational drive unit is shown in FIG. 1. The illustration of the display unit 3 is omitted in FIG. 2. An engaging protrusions 12a is protrusively provided at two places on the side at the end of the clamper 12 to be engaged with and disengaged from an engaging recess 6a with the rotation of the clamper 12.

When the display unit 3 is pushed in the direction of an arrow as shown in FIG. 1(a), the rotational drive unit converts the reciprocating motion into a rotational motion; thus, the clamper 12 is caused to rotate by 90 degrees as shown in FIG. 1(b) and FIG. 2(b), the engagement of the engaging protrusions 12a and the engaging recess 6a are released to open the display unit 3. In the case where the opened clamper 12 is closed in the direction of the housing 2, when the clamper 12 is pressed by the display unit 3, the clamper 12 is rotated by 90 degrees again and the engaging protrusions 12a is engaged with the clamper engaging hole 6, so that the display unit 3 is clamped in the state in FIG. 1(a) and FIG. 2(a).

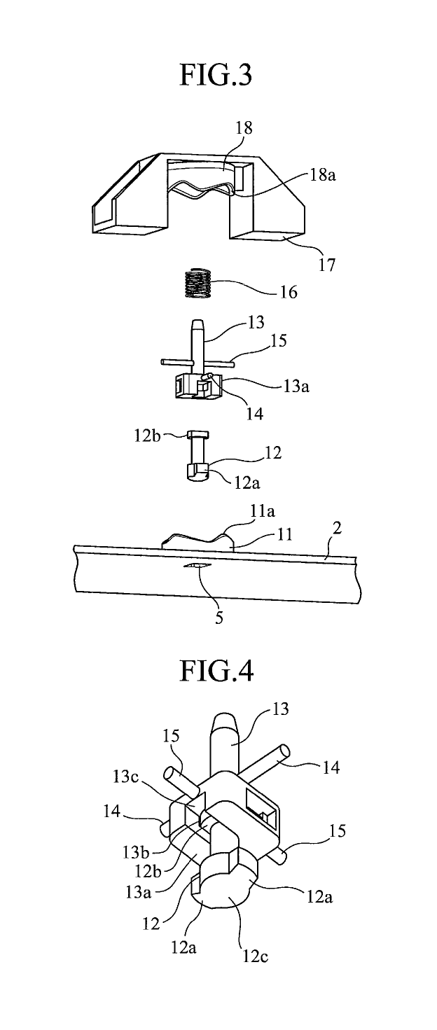

An exploded perspective view of the display lock device 10 is shown in FIG. 3. The aforementioned rotational drive unit is composed of a housing-side guide portion (second guide portion) 11, a shaft 13, a housing-side guide arm (second guide arm) 14, a holder-side guide arm (first guide arm) 15, a spring (urging means) 16, a holder 17 and a holder-side guide portion (first guide portion) 18, and is fixed to the outer face of the housing 2. A clamper insertion hole 5 for insertion of the clamper 12 is formed in the housing 2.

The housing-side guide portion 11 is formed on the outer face of the housing 2, and is provided with a serrated irregular portion 11a at the peripheral edge (rim) of a housing-side guide portion 11. A holder-side guide portion 18 is also formed at the holder 17 to be mounted on the outer face of the housing 2, such that a serrated irregular portion 18a is likewise provided at the peripheral edge thereof. The irregular portions 11a, 18a are disposed to face each other at a distance.

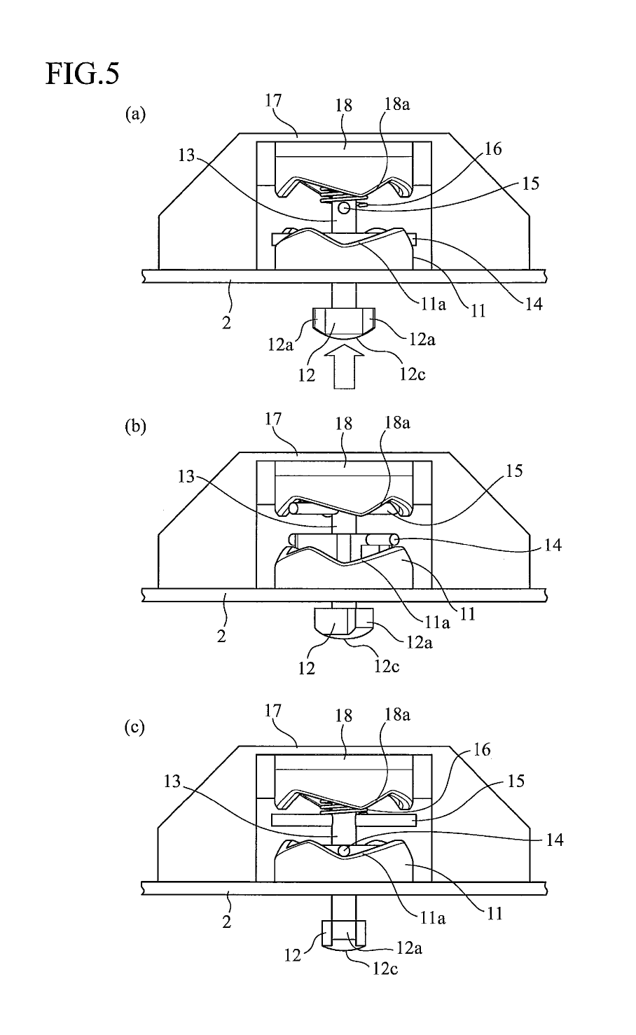

As shown in FIG. 4, a fitting portion 12b of the clamper 12 is fitted in a fitting hole 13b of a pedestal 13a that is formed on the shaft 13 to be integrated therewith. The details of the integration of the clamper 12 and the shaft 13 will be described later.

The engaging protrusions 12a for clamping the display unit 3 are provided at two places, right and left, at the end of the clamper 12 on the side of the housing 2, and are inserted into the clamper engaging hole 6 of the display unit 3 to be engaged with the engaging recess 6a with passing through a clamper insertion hole 5 of the housing 2. Also, an end face 12c is rounded to have a spherical surface shape to render a point contact with the bottom face of the clamper engaging hole 6, so that the friction upon the rotation of the clamper 12 is reduced.

As shown in FIG. 4 and FIG. 5, a housing-side guide arm 14 to be slid along the irregular portion 11a of the housing-side guide portion 11, and a holder-side guide arm 15 to be slid along the irregular portion 18a of the holder-side guide portion 18 are protrusively provided on the shaft 13 at two steps and perpendicular to each other. In the illustrated example, the holder-side guide arm 15 is protrusively provided at a position close to the holder 17 on the outer peripheral face of the shaft 13, and the housing-side guide arm 14 is protrusively provided on the side of the pedestal 13a that is closer to the housing 2 than the holder-side guide arm 15. The spring 16 that urges the shaft 13 together with the clamper 12 toward the housing 2 is installed at the base end of the shaft 13 on the holder 17 side.

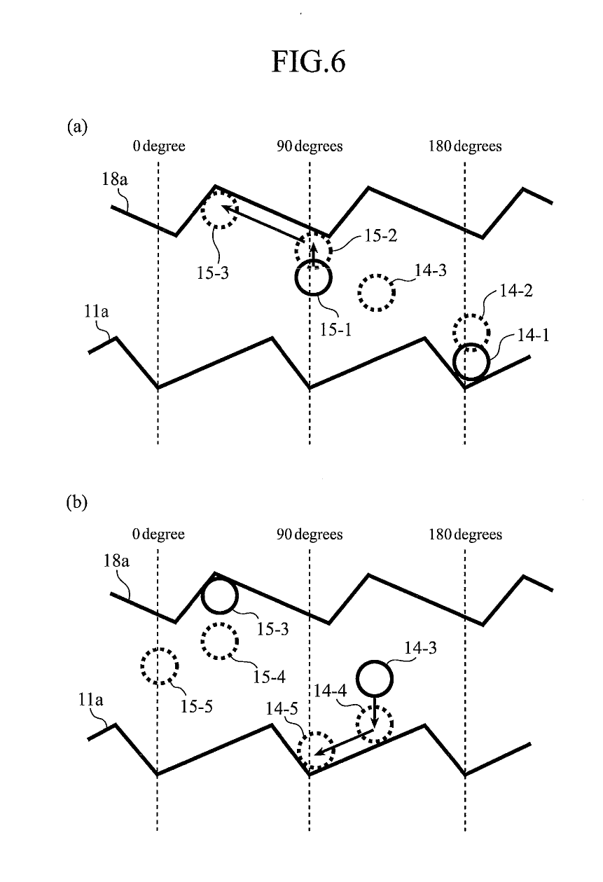

Next, the operation of the display lock device 10 will be described with reference to FIG. 5 and FIG. 6. In Embodiment 1, as mentioned above, it is schemed that each 90-degree rotation of the clamper 12 in the display lock device 10 enables to switch between a locked state and a lock-released state in the display unit 3. As shown in FIG. 6, the irregular shapes of the irregular portion 11a and of the irregular portion 18a has troughs and ridges formed over 360 degrees with 90-degree repetitions. The phases of the troughs and ridges of the irregular portion 11a and the irregular portion 18a are shifted from each other. In FIG. 6, a section corresponding to 0-180 degrees is illustrated with excerpted from 0-360 degrees.

During the locked state shown in FIG. 5(a), the clamper 12 and shaft 13 are drawn in a downwards direction due to the weight of the display unit 3 (not shown) that is engaged with the engaging protrusions 12a, so that the housing-side guide arm 14 is come into contact with the irregular portion 11a of the housing-side guide portion 11. At this time, the housing-side guide arm 14 is come into contact with the irregular portion 11a with located at rotation position 14-1 in FIG. 6(a), while the holder-side guide arm 15 is located at rotation position 15-1.

When the display unit 3 is pressed in the direction of the arrow shown in FIG. 5(a), the clamper 12 is pressed by the display unit 3 to be moved forward as shown in FIG. 5(b). At this time, as shown in FIG. 6(a), the holder-side guide arm 15 is moved from rotation position 15-1 to rotation position 15-2 to be come into contact with the irregular portion 18a; in the abutting state, the guide arm is slid along the irregular shape up to rotation position 15-3 to be stopped by hitting on the rising portion of the irregular shape. The other housing-side guide arm 14 is also moved from rotation position 14-2 to rotation position 14-3 by following the holder-side guide arm 15. Further, the clamper 12 is rotated by following the holder-side guide arm 15.

When the pressing onto the display unit 3 is released, the clamper 12 and the shaft 13 is urged downwards to be moved backward due to the urging force of the spring 16 as shown in FIG. 5(c). At this time, as shown in FIG. 6(b), the holder-side guide arm 14 is moved from rotation position 14-3 to rotation position 14-4 to be come into contact with the irregular portion 11a; in the abutting state, the holder-side guide arm 14 is slid along the irregular shape up to rotation position 14-5 to be stopped by hitting on the rising portion of the irregular shape. The other housing-side guide arm 15 is also moved from rotation position 15-4 to rotation position 15-5 by following the holder-side guide arm 14. Further, the clamper 12 is rotated by following the holder-side guide arm 14.

In such a way, when one reciprocating motion of the clamper 12 is vertically complete, the housing-side guide arm 14 and the holder-side guide arm 15 are rotated by 90 degrees to convert a reciprocating motion into a rotational motion; thus, the clamper 12 is rotated by 90 degrees to release the engagement between the engaging protrusions 12a and the engaging recess 6a, resulting in the lock-released state. When one reciprocating motion of the clamper 12 is complete again, the clamper is rotated by 90 degrees correspondingly to engage the engaging protrusions 12a with the engaging recess 6a, resulting in the locked state.

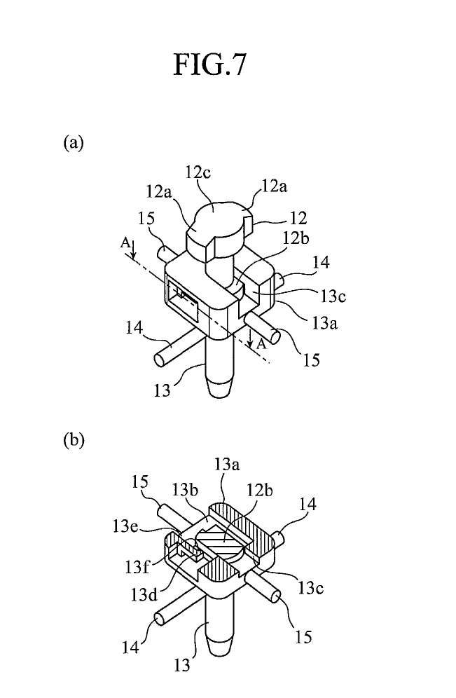

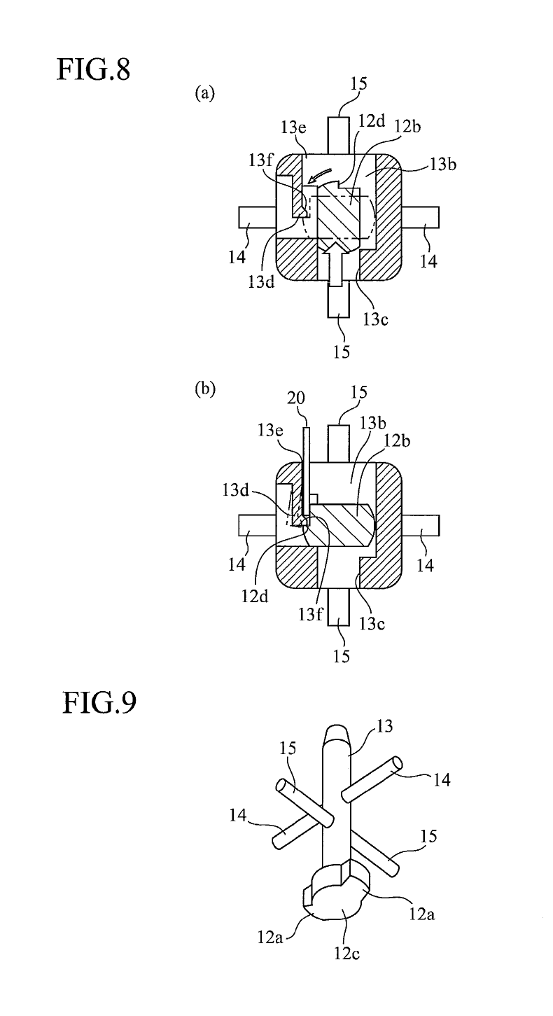

Next, the details of an integrated structure of the clamper 12 and the shaft 13 will be described. FIG. 7(a) is an external perspective view of the integrated structure of the clamper 12 and the shaft 13, and FIG. 7(b) is a cross-sectional view taken along line AA. Also, FIG. 8 is a plan view of the integrated structure shown in FIG. 7(b); FIG. 8(a) shows an integrating procedure thereof, and FIG. 8(b) shows a disassembling procedure thereof.

To integrate the clamper 12 with the shaft 13, an oval-shaped fitting portion 12b is provided at the base end side of the clamper 12, and a pedestal 13a is provided on the other shaft 13 to form a slit 13c and a fitting hole 13b. Upon integration of the clamper 12 and the shaft 13, the fitting portion 12b of the clamper 12 is inserted into the fitting hole 13b through the slit 13c with sliding, as shown in FIG. 8(a), and is rotated in the fitting hole 13b to latch a notch 12d to an elastic latching claw 13d. Since the slit 13c is narrower than the fitting hole 13b, no fitting portion 12b comes off due to a further rotation.

When the clamper 12 and the shaft 13 is disassembled, a jig 20 is inserted through a jig insertion hole 13e of the shaft 13 to push and spread a latching claw 13d, thereby releasing the latching between the latching claw 13d and the notch 12d. As mentioned above, since no screws are employed for the integration of the clamper 12 and the shaft 13, both assembly and disassembly thereof can be easily carried out. Also, when the clamper 12 and the shaft 13 are configured by separate entities, the material, shape, color and so forth are modified between the clamper 12 exposed to the exterior and the shaft 13 not exposed to the exterior, thereby enhancing the designability.

Further, when a tapered shape 13f is prepared to the face of the latching claw 13d to be pressed by the jig 20, the jig 20 can be readily inserted into a gap between the latching claw 13d and the notch 12d, resulting in a structure to be disassembled more easily.

As described above, according to Embodiment 1, it is configured that the display lock device 10 that locks the opening and closing of the display unit 3 includes: the clamper 12 to be reciprocated due to the pressing of the display unit 3 when the display unit 3 is pressed; the spring 16 that urges the clamper moved forward under the pressing of the display unit 3 to be moved backward; the rotational drive unit connected to one end of the clamper 12 to converts a reciprocating motion into a rotational motion to thus rotate the clamper 12; and the engaging protrusions 12a protrusively provided on the side of the clamper 12 to be engaged with or disengaged from the engaging recess 6a formed in the display unit 3 with the rotation of the clamper 12. For this reason, when the display unit 3 is directly pressed to rotate the clamper 12, the locked state and the lock-released state can be changed. Therefore, a lock release button, as is contained in conventional display lock structures, can be eliminated, and no space for the lock release button would be eliminated in the housing 2.

According to Embodiment 1, it is configured that the rotational drive unit includes: the cylindrical holder-side guide portion 18 at the peripheral edge of which the serrated irregular portion 18a is formed; the cylindrical housing-side guide portion 11 at the peripheral edge of which the serrated irregular portion 11a is formed, such that the irregular portion 11a is disposed to face the irregular portion 18a of the holder-side guide portion 18; the shaft 13 integrated with the clamper 12; the holder-side guide arm 15 protrusively provided on the side of the shaft 13 and positioned between the housing-side guide portion 11 and the holder-side guide portion 18 to be come into contact with the holder-side guide portion 18 with a forward motion of the clamper 12 to be rotated along the irregular portion 18a; and the housing-side guide arm 14 protrusively provided on the side of the shaft 13 in a direction different from that of the holder-side guide arm 15 and close to the housing-side guide portion 11 to be come into contact with the housing-side guide portion 11 with a backward motion of the clamper 12 to be rotated along the irregular portion 11a. For this reason, the reciprocating motion of the clamper 12 can be converted into the rotational motion; as a result, the display unit 3 can be switched between the locked state and the lock-released state.

According to Embodiment 1, it is also configured that the contact surface of the clamper 12 to be pressed by the display unit 3 is provided with the end face 12c having a spherical surface shape to render a point contact therewith, so that the friction upon the rotation of the clamper 12 can be reduced.

According to Embodiment 1, it is also configured as follows: the pedestal 13a is provided in the shaft 13; the slit 13c and the fitting hole 13b are formed in the pedestal 13a; the oval-shaped fitting portion 12b is provided in the clamper 12; the fitting portion 12b is inserted into the fitting hole 13b through the slit 13c with sliding, and rotated within the fitting hole 13b to be fitted therein to thus integrate the shaft 13 with the clamper 12. For this reason, the clamper 12 and the shaft 13 can be easily assembled without using any screws, and can be easily disassembled. The designablity can also be enhanced since the clamper 12 and the shaft 13 are formed by separate entities.

Incidentally, in the above Embodiment 1, the following configuration is described by way of example: the display lock device 10 is applied to the ceiling hanging display device such that the display unit is opened in the gravity direction; however it is not limited thereto; and may be applied to a display device having a configuration such that the display unit is opened against the gravity direction.

In the above Embodiment 1, the engaging protrusions 12a are provided at the two places in right and left; however, it is sufficient to be provided with at least the engaging protrusion 12a at one place.

In the above Embodiment 1, the following configuration is shown: the fitting portion 12b provided in the clamper 12 and the pedestal 13a provided in the shaft 13 are connected with each other; reversely, the pedestal provided in the clamper 12 and the fitting portion provided in the shaft 13 may be connected with each other. Alternatively, the clamper 12 and the shaft 13 may be integrally formed beforehand, as shown in FIG. 9. In the configuration of FIG. 9, the pedestal 13a is omitted, while the clamper 12 and the shaft 13 are formed as a single part, and further the holder-side guide arm 15 is protrusively provided at a position corresponding to the pedestal 13a of the shaft 13.

Also, the housing-side guide arm 14 and the holder-side guide arm 15 are perpendicular to each other; however, the intersection angle is not limited thereto, and may be appropriately designed in accordance with the irregular shapes of the irregular portions 11a, 18a of the housing-side guide portion 11 and the holder-side guide portion 18.

### INDUSTRIAL APPLICABILITY

As described above, in the display lock device of the present invention, it is configured that the clamper is operated through direct pressing of the display unit without using the lock release button to switch between the locked state and the lock-released state; thus, it is suitable for use in a space-saving, vehicle mounted ceiling hanging display device and so on.

1.-5. (canceled)

6. A display lock device that locks the opening and closing of a display, comprising:
a clamper to be reciprocated due to the pressing of the display when the display is pressed;
a rotational drive unit connected to one end of the clamper to convert a reciprocating motion of the clamper into a rotational motion to rotate the clamper; and
an engaging protrusion protrusively provided on a side of the clamper to be engaged with or disengaged from an engaging recess foamed in the display with the rotation of the clamper, wherein the rotational drive unit has:
a cylindrical first guide portion provided with a serrated irregular shape on a peripheral edge thereof;
a cylindrical second guide portion provided with a serrated irregular shape on a peripheral edge thereof, such that the irregular shape is disposed to face the irregular shape of the first guide portion;
a shaft integrated with the clamper;
a first guide arm protrusively provided on the side of the shaft and positioned between the first guide portion and the second guide portion to be come into contact with the first guide portion with a forward motion of the clamper to be rotated along the irregular shape;
a second guide arm protrusively provided on the side of the shaft in a direction different from that of the first guide arm and close to the second guide portion to be come into contact with the second guide portion with a backward motion of the clamper to be rotated along the irregular shape.

7. The display lock device according to claim 6, wherein a pedestal is provided in one of the shaft and the clamper, and a slit and a fitting hole are formed in the pedestal, and wherein an oval-shaped fitting portion is provided in the other one of the shaft and the clamper, the fitting portion is inserted into the fitting hole through the slit with sliding to be fitted therein within the fitting hole with a rotation to integrate the shaft and the clamper.
